(19) United States
(12) Patent Application Publication
(10) Pub. No.: US 2007/0158421 A1
(43) Pub. Date: Jul. 12, 2007

(54) Scanners

(75) Inventor: Tsung-Te Lin, Taipei (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/619,732

(22) Filed: Jan. 4, 2007

(30) Foreign Application Priority Data
Jan. 11, 2006 (TW) TW95101021

(51) Int. Cl. G06K 7/10

(52) U.S. Cl. 235/454

(57) ABSTRACT

Scanners are provided. A scanner includes a scan module, a separator, and a housing having a transparent plate. The scanning module is movably received in the housing to scan a first object or a second object through the transparent plate. The separator includes a rotary member and a main body connected to the scan module. The rotary member connects the main body and movably contacts the transparent plate. When the rotary member is at a first angle, the first object is located in a depth of field (DOF) of the scan module. When the rotary member rotates from the first angle to a second angle, the scan module moves toward the transparent plate, such that the second object is retained in the depth of field.

### BACKGROUND OF THE INVENTION

1. Field of the Invention

The invention relates in general to scanners and in particular to scanners having separators.

2. Description of the Related Art

A conventional Contact Image Sensor (CIS) scanner comprises a scan module and a transparent plate on which an object to be scanned is disposed, wherein a specific space is produced between the transparent plate and the scan module by a separator, such that the object is in a fixed depth of field (DOF) of the scan module.

When scanning a small object, such as film, a holder is disposed on the transparent plate for positioning the object. However, the object can be out the depth of field due to thickness of the holder.

### BRIEF SUMMARY OF THE INVENTION

Scanners are provided. A scanner includes a scan module, a separator, and a housing having a transparent plate. The scanning module is movably received in the housing to scan a first object or a second object through the transparent plate. The separator includes a rotary member and a main body connected to the scan module. The rotary member connects the main body and movably contacts the transparent plate. When the rotary member is at a first angle, the first object is located in a depth of field (DOF) of the scan module. When the rotary member rotates from the first angle to a second angle, the scan module moves toward the transparent plate, such that the second object is retained in the depth of field.

### BRIEF DESCRIPTION OF THE DRAWINGS

The invention can be more fully understood by reading the subsequent detailed description and examples with references made to the accompanying drawings, wherein:

FIG. 1 is a perspective diagram of an embodiment of a scanner;

FIG. 2 is a perspective diagram of an embodiment of a separator of a scanner;

FIG. 3 is a perspective diagram of an embodiment of a rod connected to a separator;

FIG. 4a is a perspective diagram of a moving path of a protrusion of a rod when a guiding member is aligned with a first datum line;

FIG. 4b is a side view of a scanner when a rotary member of the scanner is at a first angle;

FIG. 5a is a perspective diagram of a moving path of a protrusion of a rod when a guiding member is aligned with a second datum line; and

FIG. 5b is a side view of a scanner when a rotary member of the scanner is at a second angle.

### DETAILED DESCRIPTION OF THE INVENTION

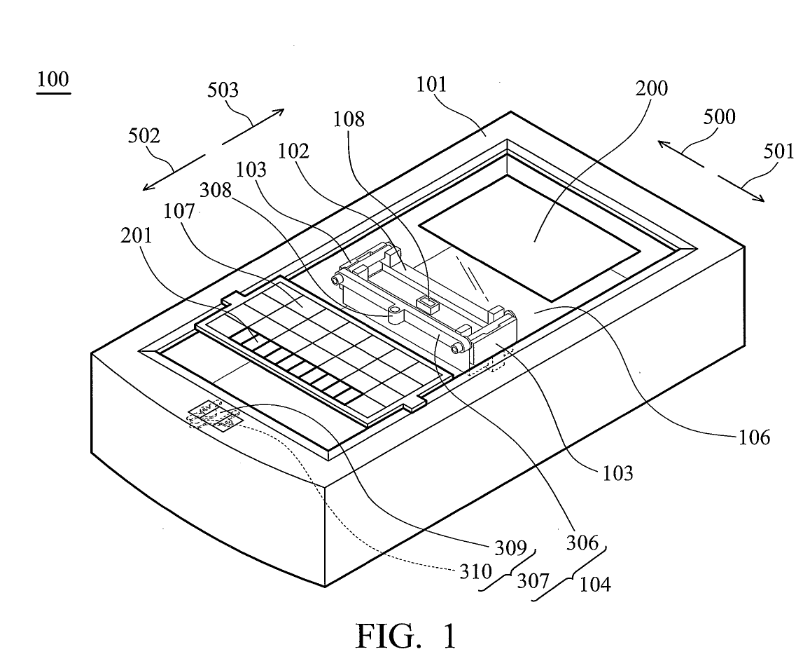

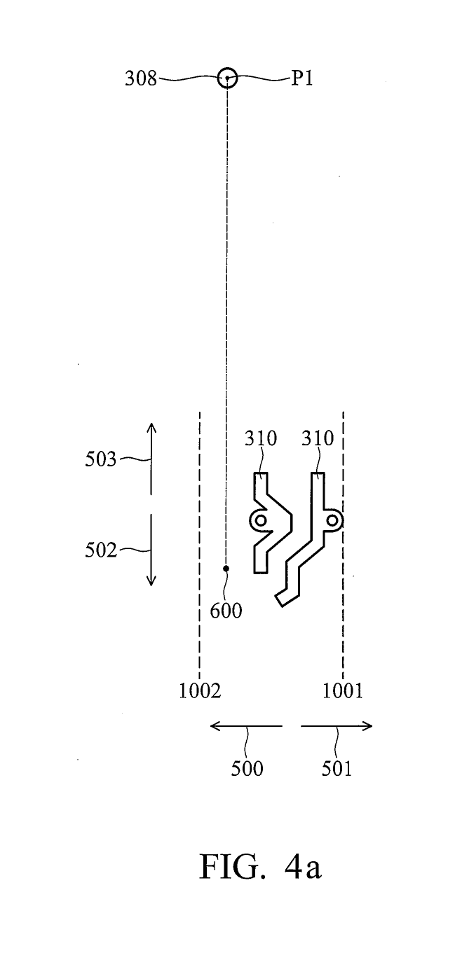

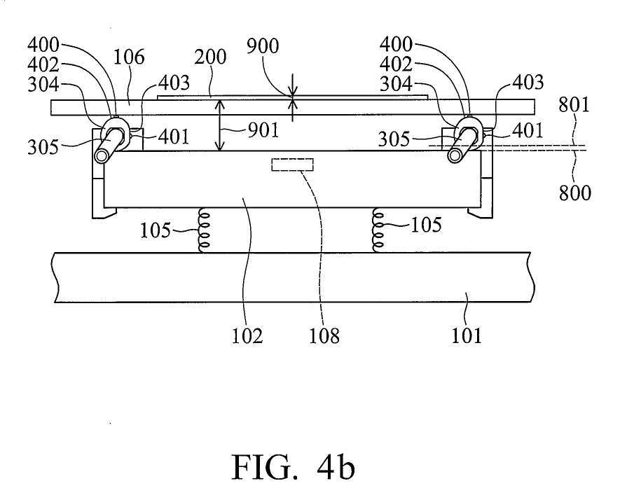

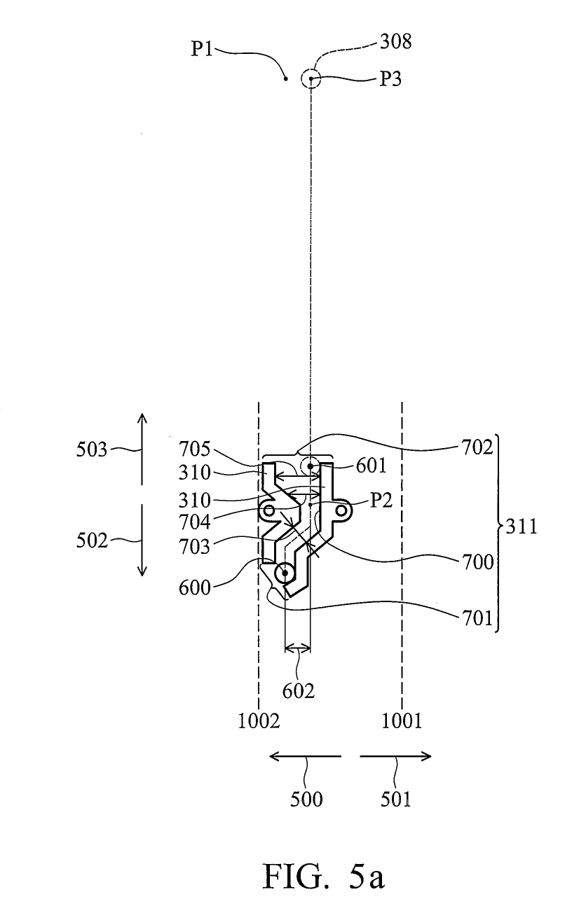

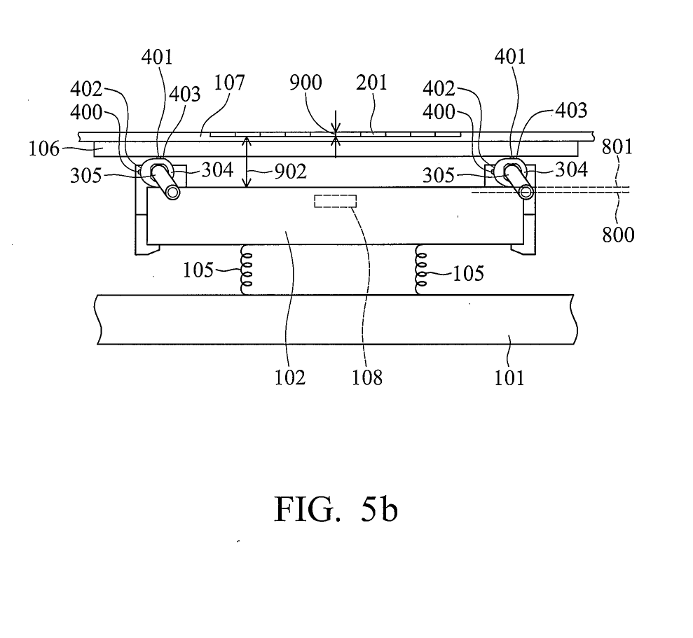

Referring to FIG. 1, an embodiment of a scanner 100 primarily comprises a housing 101, a scan module 102, a separator 103, a movable mechanism 104, and a resilient member 105 (shown in FIGS. 4b and 5b). The housing 101 comprises a transparent plate 106 with a holder 107 disposed thereon. The scan module 102 is movably disposed in the housing 101 and below the transparent plate 106, comprising a contact image sensor for selectively scanning a first object 200 on the transparent plate 106 or a second object 201 on the holder 107.

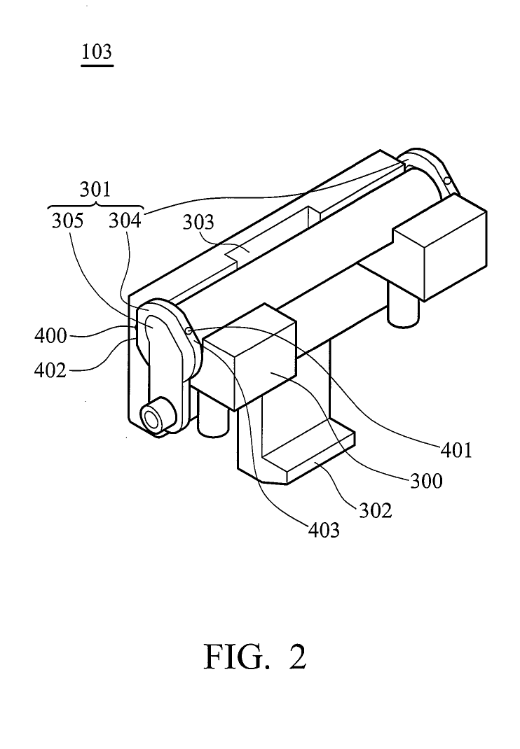

Referring to FIG. 2, the separator 103 includes a main body 300 and a rotary member 301. The main body 300 has a hook portion 302 and a recess 303. The hook portion 302 is joined to the scan module 102, such that the separator 103 and the scan module 102 are connected. As shown in FIG. 2, the rotary member 301 comprises a cam 304 and an arm 305 extending therefrom. In this embodiment, the cam 304 is pivotally connected to the recess 303, comprising a first nub 400 and a second nub 401 respectively projecting from a first flat surface 402 and a second flat surface 403 thereof.

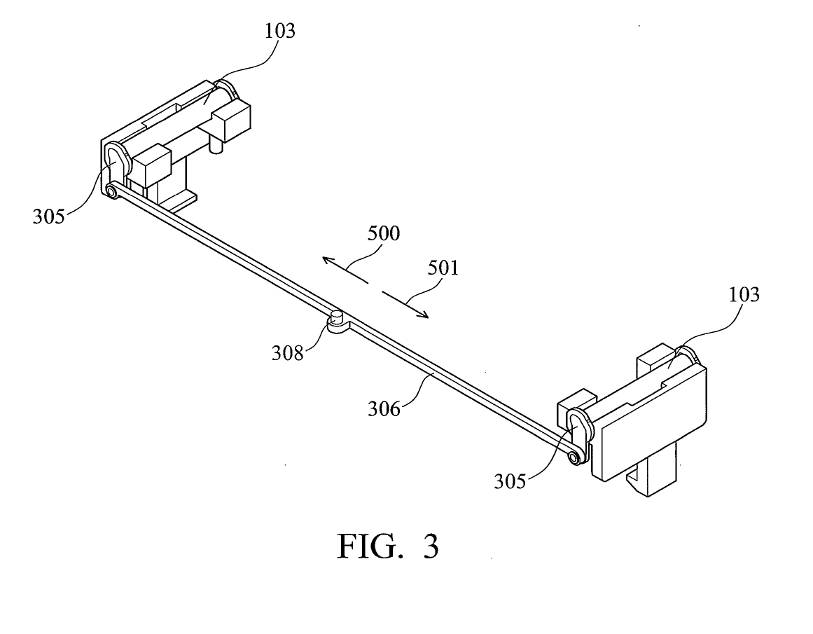

The movable mechanism 104 in FIG. 1 primarily comprises a rod 306 and a switch assembly 307. As shown in FIG. 3, the rod 306 is pivotally connected to the arm 305 and movable in a first direction 500 or a second direction 501, comprising a protrusion 308. In this embodiment, the rotary member 301 is rotated by the rod 306 between a first angle and a second angle, for scanning the first object 200 or the second object 201.

As depicted in FIG. 1, the switch assembly 307 is movably connected to the housing 101, comprising a pushbutton 309 and a movable guiding member 310. In this embodiment, the pushbutton 309 is disposed on the outer surface of the housing 101, and the guiding member 310 is received in the housing 101. The rotary member 301 is switched to the first angle or the second angle depending on the position of the switch assembly 307.

Referring to FIGS. 4b and 5b, the resilient member 105 connects the housing 101 and exerts an upward spring force on the scan module 102, such that the cam 304 pushes against the transparent plate 106, to separate the transparent plate 106 from the scan module 102 by a specific distance. In some embodiments, contact surfaces of the transparent plate 106 and the cam 304 are smooth and wear-resistant, facilitating smooth rotation of the cam 304.

When the scanner 100 is in an initial state, as shown in FIG. 4a, the protrusion 308 of the rod 306 is in a predetermined position P1, and the pushbutton 309 is moved along the second direction 501, such that the guiding member 310 is aligned with a first datum line 1001. In this state, the rotary member 301 is at a first angle, and the first nub 400 pushes against the transparent plate 106, as shown in FIG. 4b.

When scanning the first object 200, the scan module 102 moves in a third direction 502, as shown in FIG. 4a, such that the protrusion 308 of the rod 306 moves from the position P1 to a first position 600. Subsequently, the scan module 102 moves in a fourth direction 503 (opposite to the third direction 502) to scan the first object 200, while the protrusion 308 returns to the position P1. Finally, the protrusion 308 moves to the first position 600 with the scan module 102 in the third direction 502. In FIG. 4a, the protrusion 308 is in rectilinear motion between the positions P1 and 600, apart from the guiding member 310.

Referring to FIG. 4b, when the rotary member 301 is at a first angle, the first nub 400 of the cam 304 pushes against the transparent plate 106, such that the scan module 102 and the first object 200 are separated by a distance 901. Here, the scan module 102 is in a lower position 800, to ensure the first object 200 is in the depth of field 900 of the scan module 102.

However, due to thickness of the frame 107, the second object 201 may be out of the depth of field 900 when the scan module 102 is in the lower position 800. To address this problem, the rotary member 301 can be rotated from the first angle to a second angle, to adjust the distance between the second object 201 and the scan module 102, ensuring the second object 201 is within the depth of field 900, as shown in FIG. 5b.

Referring to FIG. 5a, to switch the rotary member 301 from the first angle to the second angle, the guiding member 310 must be previously aligned with a second datum line 1002 by moving the pushbutton 309 along the first direction 500, wherein the protrusion 308 is directed to an opening of the guiding member 310. Hence, during scanning of the scan module 102 along the fourth direction 503, the guiding member 310 guides the protrusion 308 from the first position 600 to a second position 601. Owing to horizontal displacement 602 of the protrusion 308 in the second direction 501, the rod 306 rotates the cam 304 and the arm 305 from the first angle (shown in FIG. 4b) to the second angle (shown in FIG. 5b).

Referring to FIG. 5a, the guiding member 310 forms a tapered passage 311 including a channel 700, a first opening 701 and a second opening 702, wherein the width 703 of the channel 700 substantially equals the protrusion 308. The width 704 of the second opening 702 exceeds the width 703 of the channel 700, such that the protrusion 308 can smoothly move through the second opening 702.

After the protrusion 308 moves with the scan module 102 from the position P to the first position 600 (shown in FIG. 4a), the guiding member 310 is moved to the left (aligned with the second datum line 1002) by pushing the pushbutton 309 along the first direction 500, as shown in FIG. 5a. When scanning, the protrusion 308 moves with the scan module 102 from the first position 600 through the channel 700 to a second position 601 with horizontal displacement 602. In detail, the protrusion 308 is guided along the guiding member 310 through position P2 to a second position 601, and moves linearly to the position P3 along the fourth direction 503. After scanning, the scan module 102 moves back along the third direction 502, such that the protrusion 308 moves from the position P3 to the position 600 through the same path.

The trajectory of protrusion 308 from the first position 600 through the position P2, the second position 601 to the position P3 is depicted as the dotted line in FIG. 5a. Due to the horizontal displacement 602 between the first and second positions 600 and 601, the rotary member 301 can be impelled by the rod 306 to the first angle shown in FIG. 4b or the second angle shown in FIG. 5b.

When the rotary member 301 is at the second angle, as shown in FIG. 5b, the second nub 401 of the cam 304 contacts the transparent plate 106. Here, the resilient member 105 lifts the scan module 102 to a higher position 801, wherein the second object 201 and the scan module 102 have a distance 902, substantially equal to the distance 901 shown in FIG. 4b. As the depth of field 900 is fixed, the second object 201 can be retained in the depth of field 900 by switching the rotary member 301 between the first and second angles, regardless of the thickness of the frame 107.

Scanners for scanning objects at different heights are provided according to the embodiments, wherein the distance between the scan module and the transparent plate is adjustable. Different objects can be retained in the depth of field of the scan module, facilitating clear canning images thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a housing, comprising a transparent plate;
a scan module, movably connected to the housing; and
a separator, comprising a rotary member and a main body connected to the scan module, the rotary member rotatably connecting the main body and movably contacting the transparent plate, wherein when the rotary member is at a first angle, the scan module and the transparent plate form a first distance therebetween, and when the rotary member is at a second angle, the scan module and the transparent plate form a second distance therebetween.

2. The scanner as claimed in claim 1, further comprising a movable mechanism, the movable mechanism comprising:
a rod, movably connected to the rotary member, comprising a protrusion; and
a switch assembly, movably connected to the housing, comprising a guiding member for guiding the protrusion between a first position and a second position, wherein when the protrusion is moved, the rotary member is moved accordingly.

3. The scanner as claimed in claim 2, wherein the guiding member comprises a tapered passage with the protrusion moved therein.

4. The scanner as claimed in claim 2, wherein the switch assembly further comprises a pushbutton disposed on an outer surface of the housing and connected to the guiding member.

5. The scanner as claimed in claim 3, wherein when the protrusion moves from the first position to the second position through the tapered passage, the rod rotates the rotary member from the first angle to the second angle.

6. The scanner as claimed in claim 1, further comprising a resilient member connecting to the housing for forcing the scan module moving toward the transparent plate.

7. The scanner as claimed in claim 1, wherein the scan module is for scanning a first object or a second object, when the rotary member is at the first angle, the first object is located in a depth of field of the scan module, and when the rotary member is at the second angle, the second object is located in the depth of field.

8. The scanner as claimed in claim 7, wherein when the rotary member is at the first angle, the second object is out of the depth of field of the scan module, and when the rotary member is at the second angle, the first object is out of the depth of field of the scan module.

9. The scanner as claimed in claim 1, wherein when the rotary member is at the first angle, the first object and the scan module are separated by a third distance, and when the rotary member is at the second angle, the second object and the scan module are separated by a fourth distance substantially equal to the third distance.

10. The scanner as claimed in claim 1, wherein the main body comprises a hook portion joined to the scan module.

11. The scanner as claimed in claim 1, wherein the rotary member comprises a smooth and wear-resistant surface contacting the transparent plate.

12. The scanner as claimed in claim 1, wherein the rotary member comprises a cam pivotally connected to the main body, wherein the cam comprises a first nub contacting the transparent plate when the rotary member is at the first angle and a second nub contacting the transparent plate when the rotary member is at the second angle.

13. The scanner as claimed in claim 12, wherein the cam further comprises a first flat surface with the first nub projecting therefrom and a second flat surface with the second nub projecting therefrom.

14. The scanner as claimed in claim 12, wherein the rotary member further comprises an arm extending from the cam.

15. The scanner as claimed in claim 14, further comprising a movable mechanism including:
a rod, movably connecting to the cam, comprising a protrusion;
a switch assembly, movably connected to the housing, comprising a guiding member having a tapered passage guiding the protrusion between a first position and a second position, wherein when the protrusion is in a first position, the first nub pushes against the transparent plate, and when the protrusion moves from the first position to the second position, the rod rotates the arm and the cam, and the second nub pushes against the transparent plate.

16. The scanner as claimed in claim 15, wherein the tapered passage has a first opening, a second opining wider than the first opening, and a channel connecting the first and second openings.

17. The scanner as claimed in claim 16, wherein the width of the channel substantially equals the protrusion.
